(19) United States
(12) Patent Application Publication
(10) Pub. No.: US 2014/0253308 A1
(43) Pub. Date: Sep. 11, 2014

(54) VEHICULAR EMERGENCY REPORT APPARATUS

(71) Applicant: DENSO CORPORATION, Kariya-city (JP)

(72) Inventor: Atsushi Kanda, Kariya-city (JP)

(73) Assignee: DENSO CORPORATION, Kariya-city (JP)

(21) Appl. No.: 14/195,061

(22) Filed: Mar. 3, 2014

(30) Foreign Application Priority Data
Mar. 8, 2013 (JP) 2013-046850

(51) Int. Cl. B60Q 9/00

(52) U.S. Cl. CPC B60Q 9/008
USPC 340/436

(57) ABSTRACT

A vehicular emergency report apparatus includes a collision detection section, an emergency report section, and a counting section. The collision detection section detects an occurrence of a vehicle-pedestrian collision in which a vehicle collides with one or more pedestrians. The emergency report section reports the vehicle-pedestrian collision to an emergency center when the collision detection section detects the occurrence of the vehicle-pedestrian collision. The counting section counts the number of the one or more pedestrians in collision with the vehicle. The emergency report section transmits the number of the one or more pedestrians in collision with the vehicle to the emergency center when reporting the vehicle-pedestrian collision to the emergency center.

### CROSS REFERENCE TO RELATED APPLICATION

This application is based on Japanese Patent Application No 2013-046850 filed on Mar. 8, 2013, the disclosure of which is incorporated herein by reference.

### TECHNICAL FIELD

The present disclosure relates to a vehicular emergency report apparatus that performs an emergency report when a vehicle collides with a pedestrian.

### BACKGROUND

As disclosed in JP 2010-244167 A, a sensor equipped to a vehicle detects a vehicle collision with a pedestrian, and an emergency report apparatus reports the collision to an emergency center when the sensor detects the vehicle collision.

In above-described configuration, when the collision occurs, the emergency report apparatus transmits multiple information, such as a vehicle speed, a collision energy, the number of vehicle occupants, seat belt wearing state, collision direction, whether the vehicle rolls over or not, whether the pedestrian is an adult or a child, and whether the collision results in a physical injury or a property damage. Since the emergency center is informed details of the collision accident, the emergency center is able to cope with the collision accident meticulously.

However, in the above-described configuration, when one or more pedestrians collide with the vehicle, the number of the pedestrians in collision with the vehicle cannot be clarified.

### SUMMARY

In view of the foregoing difficulties, it is an object of the present disclosure to provide a vehicular emergency report apparatus that counts the number of pedestrians having a collision with the vehicle.

According to an aspect of the present disclosure, a vehicular emergency report apparatus includes a collision detection section, an emergency report section, and a counting section. The collision detection section detects an occurrence of a vehicle-pedestrian collision in which a vehicle collides with one or more pedestrians. The emergency report section reports the vehicle-pedestrian collision to an emergency center when the collision detection section detects the occurrence of the vehicle-pedestrian collision. The counting section counts the number of the one or more pedestrians in collision with the vehicle. The emergency report section transmits the number of the one or more pedestrians in collision with the vehicle to the emergency center when reporting the vehicle-pedestrian collision to the emergency center.

With the above apparatus, the number of the pedestrians in collision with the vehicle can be clarified, and the number of the pedestrians in collision with the vehicle can be transmitted to the emergency center. Thus, necessary measures can be taken at the emergency center corresponding to the number of the pedestrians in collision with the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a vehicular emergency report apparatus according to an embodiment of the present disclosure;

FIG. 2 is a flowchart showing an emergency report process executed by the vehicular emergency report apparatus;

FIG. 3 is a diagram showing a counting method of the collision numbers of the vehicle with the pedestrians; and

FIG. 4 is a diagram showing an example of accident information transmitted to an emergency center.

### DETAILED DESCRIPTION

The following will describe embodiments of the present disclosure with reference to accompanying drawings.

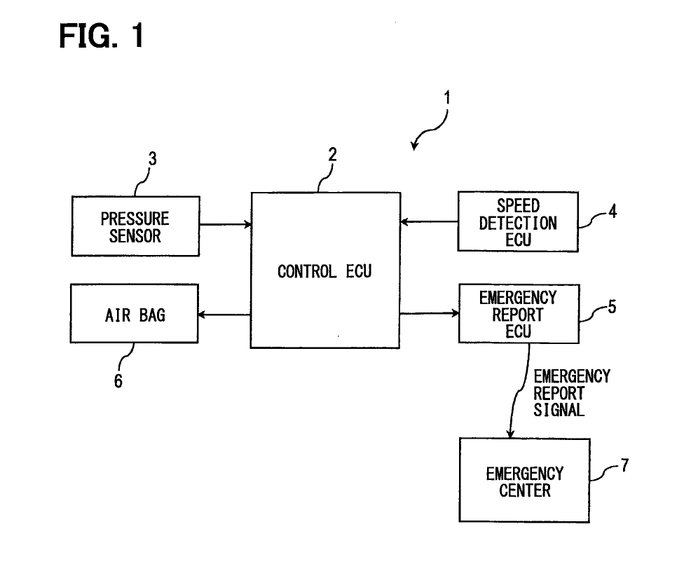

As shown in FIG. 1, a vehicular emergency report apparatus 1 includes a control electronic control unit (ECU) 2, a pressure sensor 3, a speed detection ECU 4, and an emergency report ECU 5. The control ECU 2 functions as a counting section and an end determination section. The pressure sensor 3 functions as a collision detection section, and the emergency report ECU 5 functions as an emergency report section.

The control ECU 2 mainly includes a central processing unit (CPU), and controls an operation of the vehicular emergency report apparatus 1. The control ECU 2 is electrically connected with the pressure sensor 3, the speed detection ECU 4, the emergency report ECU 5, and an air bag 6 that protects a vehicle occupant.

The pressure sensor 3 detects a bumper pressure applied to a bumper of the vehicle. The bumper includes a chamber part made of resin material and has a hollow structure. For example, two pressure sensors 3 may be equipped to the chamber part, and detect an inside pressure of the chamber part. When a collision of the vehicle with one or more pedestrians occurs, the pressure sensor 3 detects a change of the bumper pressure, and transmits a signal indicating the bumper pressure to the control ECU 2. Herein, the change of the bumper pressure is a change of the inside pressure of the chamber part caused by a deformation of the bumper. In the present embodiment, the pressure sensor 3 detects the collision of the vehicle with one or more pedestrians based on the bumper pressure. Hereinafter, the collision of the vehicle with one or more pedestrians is also referred to as a vehicle-pedestrian collision (VH-PDST COLLISION).

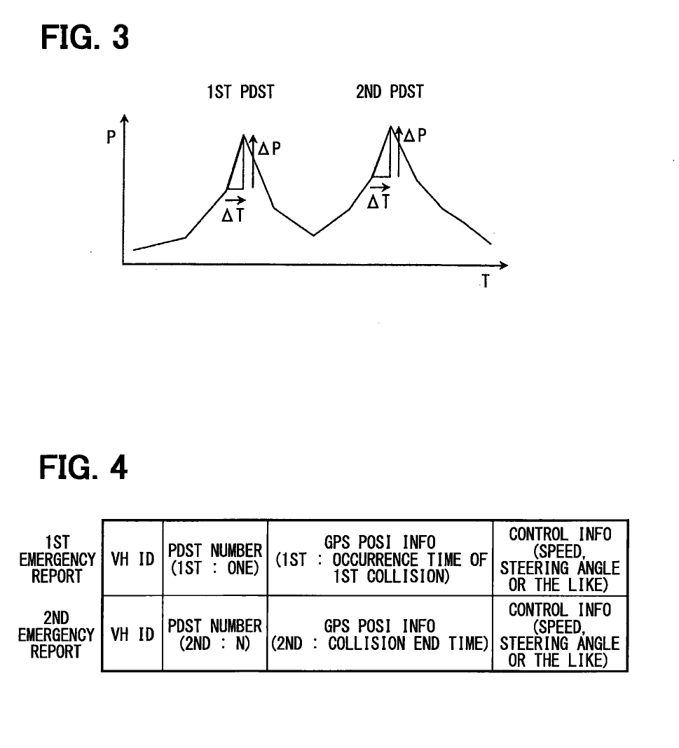

FIG. 3 shows a change of the bumper pressure (P) over time (T). As shown in FIG. 3, the pressure sensor 3 determines whether a change rate of the bumper pressure, that is ΔP/ΔT, is equal to or higher than a predetermined threshold. Herein, the change rate of the bumper pressure is an increase amount of the bumper pressure per unit time. For example, the predetermined threshold may be set to a minimum change rate of the bumper pressure generated in the vehicle-pedestrian collision. When the change rate of the bumper pressure is equal to or higher than the predetermined threshold, the pressure sensor 3 determines that the vehicle collides with one or more pedestrians. Then, the control ECU 2 counts the number of the pedestrians in collision with the vehicle based on a detection result of the pressure sensor 3. Specifically, the control ECU 2 counts the number of points in the bumper pressure, which has the change rate equal to or higher than the predetermined threshold, in order to count the number of pedestrians in collision with the vehicle. In an example shown in FIG. 3, two points in the bumper pressure have the change rates equal to or higher than the predetermined threshold. Thus, the control ECU 2 counts the number of the pedestrians in collision with the vehicle as two.

The speed detection ECU 4 includes a speed sensor, and detects a speed of the vehicle. The speed detection ECU 4 transmits a signal indicating the speed of the vehicle to the control ECU 2.

In the present embodiment, the emergency report ECU 5 is provided by a data communication module (DCM), and reports an occurrence of a trouble related to the vehicle, such as a collision of the vehicle, to an external facility, such as an external emergency center 7 as shown in FIG. 1.

When the vehicle-pedestrian collision occurs, that is when the pressure sensor 3 detects the occurrence of the vehicle-pedestrian collision, the control ECU 2 transmits an emergency report signal to the emergency report ECU 5, and the emergency report ECU 5 reports the emergency, that is, the vehicle-pedestrian collision, to the emergency center 7 by a wireless communication. Specifically, the emergency report ECU 5 receives the emergency report signal and accident information from the control ECU 2. Then, the emergency report ECU 5 transmits the emergency report signal and the accident information to the emergency center 7. When an operator stationed at the emergency center 7 receives the emergency information, such as an accident or an emergency medical need, the operator of the emergency center 7 is able to communicate with a driver of the vehicle via a communication device equipped to the emergency report ECU 5 or a mobile phone of the driver. Then, the operator of the emergency center 7 reports the emergency to the police or a hospital when necessary.

The air bag 6 is equipped to a steering wheel of the vehicle arranged in front of a driver seat of the vehicle. The air bag 6 is also equipped to an instrument panel arranged in front of a front passenger seat of the vehicle. When a vehicle accident, such as a collision, occurs, the air bag 6 is inflated to absorb energy caused by the vehicle accident and protects the vehicle occupant from the accident. When an acceleration of the vehicle detected by an accelerometer (not shown), such as a G-sensor, becomes equal to or greater than a predetermined value, the control ECU 2 determines that a collision occurs and determines that an inflation of the air bag 6 is necessary. Then, the control ECU 2 transmits an activation signal to the air bag 6 to inflate the air bag 6.

The control ECU 2 includes a timer (not shown) that is embedded in the control ECU 2. The timer starts operation when the pressure sensor 3 detects the occurrence of the vehicle-pedestrian collision. In the present embodiment, the timer counts a predetermined time period from an occurrence time of the vehicle-pedestrian collision. The predetermined time period may be set to several minutes.

Further, the control ECU 2 includes a memory (not shown) embedded in the control ECU 2. The memory may be provided by a non-volatile memory, and stores accident information. As shown in FIG. 4, for example, the accident information includes the number of pedestrians in collision with the vehicle, position information (POSI INFO) of the vehicle detected by a global positioning system (GPS) at the occurrence time of the vehicle-pedestrian collision, vehicle control information, such as the vehicle speed and a steering angle of the vehicle. The control ECU 2 transmits the accident information stored in the memory together with the emergency report signal to the emergency report ECU 5.

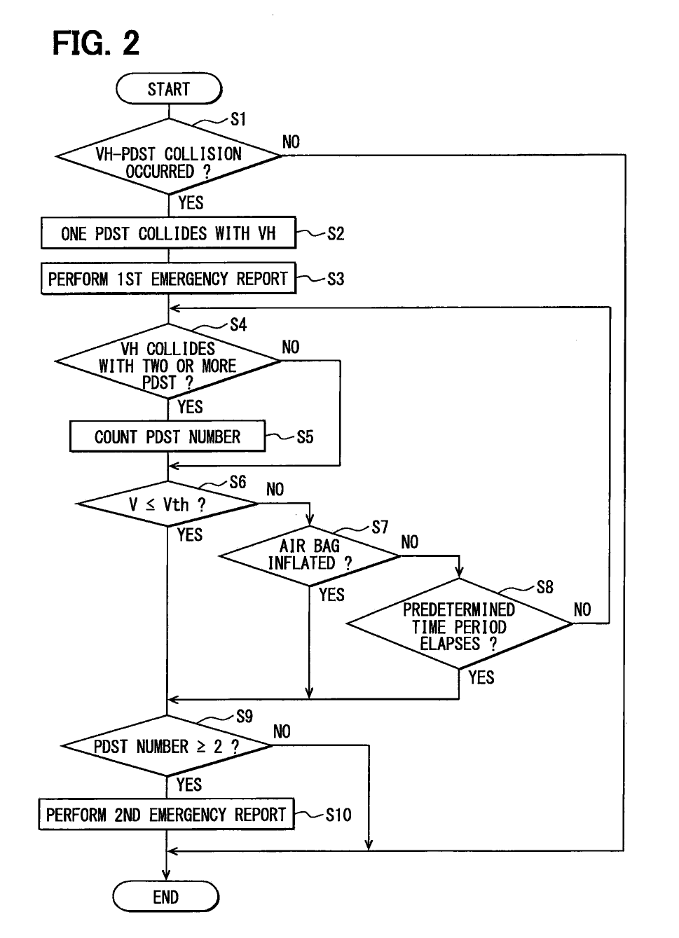

The following will describe an emergency report process executed by the vehicular emergency report apparatus 1 with reference to FIG. 2. FIG. 2 shows an example of the emergency report process, and the emergency report process is not limited to the example shown in FIG. 2.

At S1, the pressure sensor 3 of the vehicular emergency report apparatus 1 determines whether the vehicle-pedestrian collision occurs. When the pressure sensor 3 determines that the vehicle-pedestrian collision occurs (S1: YES), the control ECU 2 sets the number of the pedestrians in collision with the vehicle to one as default at S2. The pedestrian in collision with the vehicle is also referred to as an injured pedestrian. Then, the control ECU 2 transmits the emergency report signal and the accident information to the emergency report ECU 5 as shown in FIG. 1. At S3, the emergency report ECU 5 performs a first emergency report to the emergency center 7 based on the emergency report signal transmitted from the control ECU 2. In the first emergency report, the emergency report ECU 5 reports the occurrence of the vehicle-pedestrian collision to the emergency center 7. Together with the report of the occurrence of the vehicle-pedestrian collision, as shown in FIG. 4, the emergency report ECU 5 transmits the accident information, such as a vehicle identification (ID), the number of the pedestrians in collision with the vehicle (in the case shown in FIG. 4 is one pedestrian), the GPS position information (GPS POSI INFO) of the vehicle at the occurrence time of the vehicle-pedestrian collision, and the vehicle control information (vehicle speed, steering angle or the like), to the emergency center 7. When the operator of the emergency center 7 confirms the first emergency report, the operator reports the occurrence of the vehicle-pedestrian collision to the police or to the hospital as the emergency report service. Thus, necessary measures can be taken at the emergency center corresponding to the number of the pedestrians in collision with the vehicle.

At S4, the pressure sensor 3 determines whether the vehicle collides with two or more pedestrians. When the pressure sensor 3 determines that the vehicle collides with two or more pedestrians (S4: YES), at S5, the control ECU 2 counts the number of the pedestrians based on the change rate of the bumper pressure detected by the pressure sensor 3. Specifically, as shown in FIG. 3, the control ECU 2 counts the number of the points in the bumper pressure, which have the change rates equal to or higher than the predetermined threshold, in order to count the number of the pedestrians in collision with the vehicle. Herein, the change rate of the bumper pressure is the increase amount of the bumper pressure per unit time. In the example shown in FIG. 3, two points in the bumper pressure have the change rates equal to or higher than the predetermined threshold. Thus, the number of the pedestrians in collision with the vehicle is counted as two by the control ECU 2. The number of the pedestrians in collision with the vehicle is stored in the memory as the accident information as described above.

When the pressure sensor 3 determines that the counting of the pedestrians in collision with the vehicle has finished or the vehicle collides with less than two pedestrians (S4: NO), the control ECU 2 determines whether the vehicle speed (V) is equal to or lower than a predetermined speed (Vth) at S6. Then, at S7, the control ECU 2 determines whether the air bag 6 of the vehicle is inflated or not. Then, at S8, the control ECU 2 determines whether the predetermined time period counted by the timer has elapsed or not from the occurrence time of the vehicle-pedestrian collision. In the present embodiment, any one of the determinations at S6 to S8 is a predetermined condition to determining an end of the vehicle-pedestrian collision. Herein, the end of the vehicle-pedestrian collision is an end of a series of collisions in which the vehicle collides with multiple pedestrians by multiple times. Specifically, when the vehicle speed is equal to or lower than the predetermined speed (S6: YES), or the air bag 6 is inflated (S7: YES), or the predetermined time period counted by the timer has elapsed (S8: YES), the accident is deemed to be ended.

In the present disclosure, the control ECU 2 functions as the end determination section that determines whether one of the predetermined conditions set at S6 to S8 is satisfied. The predetermined condition in S6 is also referred to as a first predetermined condition, the predetermined condition in S7 is also referred to as a second predetermined condition, and the predetermined condition in S8 is also referred to as a third predetermined condition. At S6, when the control ECU 2 determines that the vehicle speed detected by the speed detection ECU 4 is equal to or lower than the predetermined speed, such as several kilometers per hour (S6: YES), the control ECU 2 determines that the series of the collisions of the vehicle with the pedestrians has ended since the vehicle approximately stops running.

At S6, when the control ECU 2 determines that the vehicle speed is still higher than the predetermined speed (S6: NO), the control ECU 2 further determines whether the air bag 6 of the vehicle is inflated or not at S7. At S7, when the control ECU 2 determines that the air bag 6 is inflated (S7: YES), the control ECU 2 determines that the series of the collisions of the vehicle with the pedestrians has ended since the driver is unable to perform a driving operation and the vehicle is unable to run further.

At S7, when the control ECU 2 determines that the air bag 6 is not inflated (S7: NO), the control ECU 2 further determines whether the predetermined time period has elapsed from the time at which the vehicle collides with a first pedestrian at S8. As described above, when the vehicle-pedestrian collision occurs, the timer embedded in the control ECU 2 is activated to count the predetermined time period. At S8, when the control ECU 2 determines that the predetermined time period has elapsed from the time at which the vehicle collides with the first pedestrian, that is the occurrence time of the vehicle-pedestrian collision (S8: YES), the control ECU 2 determines that the series of the collisions with the pedestrians has ended. At S8, when the control ECU 2 determines that the predetermined time period has not elapsed (S8: NO), the control ECU 2 returns to S4.

As described above, when the control ECU 2 determines that one of the predetermined conditions set at S6 to S8 is satisfied, the control ECU 2 further determines whether the number of the pedestrians in collision with the vehicle is equal to or greater than two at S9. Herein, the number of the pedestrians in collision with the vehicle is counted by the control. ECU 2, and is stored in the memory of the control ECU 2. When the control ECU 2 determines that the number of the pedestrians is equal to or greater than two (S9: YES), the emergency report ECU 5 performs a second emergency report at S10.

As shown in FIG. 4, in the second emergency report, the emergency report ECU 5 transmits the accident information, such as the vehicle ID, the number of pedestrians in collision with the vehicle (in the case shown in FIG. 4 is N pedestrians), the GPS position information of the vehicle at the occurrence time of the vehicle-pedestrian collision, and the vehicle control information (vehicle speed, steering angle), to the emergency center 7. Further, when the number of the pedestrians in collision with the vehicle is less than two (S9: NO), the control ECU 2 ends the emergency report process.

When the operator of the emergency center 7 confirms the second emergency report, the operator is able to estimate the number of necessary ambulances corresponding to the number of pedestrians in collision with the vehicle and send the necessary ambulances to the accident location. Further, the operator of the emergency center 7 may report a scale of the accident to the facility, such as the police, the hospital, or the fire and disaster management department, promptly and properly as an emergency managing measure.

As described above, the vehicular emergency report apparatus 1 according to the present embodiment includes the pressure sensor 3 that detects the occurrence of the vehicle-pedestrian collision, the emergency report ECU 5 that reports the vehicle-pedestrian collision to the emergency center 7 when the pressure sensor 3 detects the occurrence of the vehicle-pedestrian collision, the counting section provided by the control ECU 2 that counts the number of the pedestrians in collision with the vehicle. The pedestrians in collision with the vehicle are detected by the pressure sensor 3, and the emergency report ECU 5 further transmits the number of the pedestrians in collision with the vehicle to the emergency center 7.

With above-described configuration, the pressure sensor 3 detects the occurrence of the vehicle-pedestrian collision, and the control ECU 2 counts the number of the pedestrians in collision with the vehicle. Further, the emergency report ECU 5 performs the emergency report to transmit the number of the pedestrians in collision with the vehicle to the emergency center 7. Thus, the number of the injured pedestrians in the vehicle-pedestrian collision is informed to the emergency center 7, and necessary number of the ambulances can be estimated and prepared for the injured pedestrians. When a big collision accident occurs and large number of pedestrians are injured in the collision accident, the accident information is informed to each facility, such as the police, the hospital, and the fire and disaster managing department. Thus, a prompt and proper handling and relief can be carried out to all of the injured pedestrians of the collision accident.

Further, the vehicular emergency report apparatus 1 includes the end determination section provided by the control ECU 2 that determines whether the predetermined condition for determining the end of the vehicle-pedestrian collision is satisfied or not. When the pressure sensor 3 detects the first occurrence of the vehicle-pedestrian collision, that is, the pressure sensor 3 detects that the vehicle collides with the first pedestrian (S1: YES), the emergency report ECU 5 performs the first emergency report (S3). When the control ECU 2 determines that the predetermined condition is satisfied (one of S6 to S8: YES), the emergency report ECU 5 performs the second emergency report (S10).

With this configuration, the occurrence of the vehicle-pedestrian collision can be promptly informed to the emergency center 7 by the first emergency report. Further, the end of the series of the collision accidents and the total number of the injured pedestrians in collision with the vehicle can be properly informed to the emergency center 7.

Further, when the control ECU 2 determines that the predetermined condition (any one of S6 to S8) is satisfied and the number of the injured pedestrians is equal to or greater than two, the emergency report ECU 5 performs the second emergency report (S10).

With this configuration, the second emergency report is performed only when the number of the injured pedestrians is equal to or greater than two. That is, when the number of the vehicle collisions is equal to one, only the first emergency report is executed by the emergency report ECU 5. Thus, the execution number of the emergency reports can be reduced to a minimum value. Further, when the number of the vehicle collisions is equal to or greater than two, the emergency report can be avoided to be executed by multiple times corresponding to the multiple vehicle collisions, respectively. That is, even when the number of the vehicle collisions is equal to or greater than two, the accident information of the whole vehicle-pedestrian collisions is reported to the emergency center 7 in the second emergency report. Thus, a process load of the control ECU 2 and the emergency report ECU 5 is reduced and a bus load of a communication line between the emergency report ECU 5 and the emergency center 7 can be reduced. Suppose that the emergency report is performed for each occurrence of the vehicle-pedestrian collision. When a time interval between adjacent two vehicle-pedestrian collisions is short, the estimation of the injured pedestrians in each vehicle-pedestrian collision may become difficult for the operator at the emergency center 7. With above-described configuration of the present embodiment, the total number of the injured pedestrians in the series of the vehicle-pedestrian collisions is informed to the emergency center 7 with high reliability.

Further, the predetermined condition for determining the end of the vehicle-pedestrian collision is satisfied when the vehicle speed is equal to or lower than the predetermined speed (56: YES), or the air bag 6 is inflated (S7: YES), or the predetermined time period has elapsed from the occurrence time of the vehicle-pedestrian collision (S8: YES).

With this configuration, the series of vehicle-pedestrian collisions occurred until the vehicle speed reduces to the predetermined speed (S6), that is until the vehicle nearly stops running, is deemed as single vehicle-pedestrian accident. Thus, the number of the pedestrians collided with the vehicle in multiple collisions is accurately counted. Further, when the air bag 6 is inflated (S7), the driver of the vehicle is unable to drive the vehicle any more. Thus, the vehicle may be unable to collide with pedestrians any more. Thus, the number of the pedestrians in collision with the vehicle can be properly counted. Further, the second emergency report is performed right after the air bag 6 is inflated. Thus, the emergency report is performed reliably before an exhaustion of the battery for emergency use.

Further, the elapse of the predetermined time period (S8) after the occurrence of the vehicle-pedestrian collision is set as the predetermined condition for determining the end of the series of the vehicle-pedestrian collisions. Thus, when the speed detection ECU 4 has broken down or the control ECU 2 fails to send the inflation signal to the air bag 6 due to the damage caused by the collision, the end of the collision accident can be determined based on the timer. Thus, the number of pedestrians in collision with the vehicle can be properly counted.

In the present embodiment, the collision detection section is provided by the pressure sensor 3 that detects the bumper pressure of the vehicle. The pressure sensor 3 detects the occurrence of the vehicle-pedestrian collision based on the bumper pressure. The pressure sensor 3 detects the change rate of the bumper pressure generated when the pedestrian collides with the bumper of the vehicle. Thus, the vehicle-pedestrian collision can be reliably detected by the pressure sensor 3.

In the present embodiment, the counting section provided by the control ECU 2 counts the pedestrians in collision with the vehicle based on the change rate of the bumper pressure. With this configuration, the number of the collisions in which the vehicle collides with multiple pedestrians is accurately counted and accordingly the number of the pedestrians in collision with the vehicle can be accurately counted by counting the points in the bumper pressure having the change rates equal to or higher than the predetermined threshold.

### Other Embodiments

In the foregoing embodiment, the pressure sensor 3 detects the inside pressure of the chamber part arranged at an inside portion of the bumper in order to detect the vehicle-pedestrian collision. Further, one or more pressure sensors may be arranged at an inside portion of a pop-up hood, which rises up when the vehicle collides with the pedestrian, and the sensor may detect the occurrence of the vehicle-pedestrian collision. In this case, the control ECU 2 counts the number of the pedestrians in collision with the vehicle based on the change rate of the pressure detected by the pressure sensor arranged at the inside portion of the pop-up hood.

In the foregoing embodiments, the occurrence of the vehicle-pedestrian collision is detected by the pressure sensor equipped to the bumper or to the popup hood. Further, the occurrence of the vehicle-pedestrian collision may be detected by the accelerometer equipped to the bumper.

In the present embodiment, when one of the three predetermined conditions including the first predetermined condition, the second predetermined condition, and the predetermined condition is satisfied, the series of the vehicle-pedestrians collisions is deemed to be ended. Herein, the predetermined condition includes that the vehicle speed is equal to or lower than the predetermined speed (S6), or the air bag 6 is inflated (S7), or the predetermined time period has elapsed from the occurrence time of the vehicle-pedestrian collision (S8). Further, the predetermined condition may be set as only one of the three predetermined conditions (S6 to S8). For example, the control ECU 2 may determine that the series of the vehicle-pedestrian collisions ends only when the vehicle speed is equal to or lower than the predetermined speed (S6). With this configuration, the control ECU 2 counts the number of the pedestrians in collision with the vehicle without determining the inflation state of the air bag 6 or the elapse of the predetermined time period. Thus, the pedestrian in collision with the vehicle after the inflation of the air bag 6 can be also counted by the control ECU 2.

Further, instead of determining whether the air bag 6 is inflated, the control ECU 2 may determine whether the acceleration of the vehicle detected by the accelerometer becomes equal to or greater than the predetermined value to determine the end of the collision accident, that is the series of the vehicle-pedestrian collisions. The air bag 6 is inflated under a condition that the acceleration of the vehicle detected by the accelerometer becomes equal to or greater than the predetermined value. With this configuration, when the control ECU 2 fails to send the inflation signal to the air bag 6 due to the damage caused by the collision, the end of the accident can also be determined.

Further, a communication line between the control ECU 2 and the speed detection ECU 4 and a communication line between the control ECU 2 and the emergency report ECU 5 can be combined to a common communication line, such as a controller area network (CAN) communication line. With this configuration, the communication lines between the control ECU 2, the speed detection ECU 4, and the emergency report ECU 5 can be simplified.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A vehicular emergency report apparatus comprising:
a collision detection section detecting an occurrence of a vehicle-pedestrian collision in which a vehicle collides with one or more pedestrians;
an emergency report section reporting the vehicle-pedestrian collision to an emergency center when the collision detection section detects the occurrence of the vehicle-pedestrian collision; and
a counting section counting the number of the one or more pedestrians in collision with the vehicle,
wherein the emergency report section transmits the number of the one or more pedestrians in collision with the vehicle to the emergency center when reporting the vehicle-pedestrian collision to the emergency center.

2. The vehicular emergency report apparatus according to claim 1, further comprising
an end determination section determining an end of the vehicle-pedestrian collision by determining whether a predetermined condition is satisfied,
wherein, when the collision detection section detects a first pedestrian of the one or more pedestrians in collision with the vehicle, the emergency report section performs a first emergency report to the emergency center, and
wherein, when the end determination section determines that the predetermined condition for determining the end of the vehicle-pedestrian collision is satisfied, the emergency report section performs a second emergency report to the emergency center.

3. The vehicular emergency report apparatus according to claim 2,
wherein, when the end determination section determines that the predetermined condition for determining the end of the vehicle-pedestrian collision is satisfied and the number of the one or more pedestrians in collision with the vehicle is equal to or greater than two, the emergency report section performs the second emergency report to the emergency center.

4. The vehicular emergency report apparatus according to claim 2,
wherein the predetermined condition for determining the end of the vehicle-pedestrian collision is set as at least one of a first predetermined condition, a second predetermined condition, or a third predetermined condition,
wherein, when a speed of the vehicle becomes equal to or lower than a predetermined speed, the first predetermined condition is satisfied,
wherein, when an air bag equipped to the vehicle is inflated, the second predetermined condition is satisfied, and
wherein, when a predetermined time period elapses from an occurrence time of the vehicle-pedestrian collision, the third predetermined condition is satisfied.

5. The vehicular emergency report apparatus according to claim 1,
wherein the collision detection section is provided by a pressure sensor that detects a bumper pressure applied to a bumper of the vehicle, and
wherein the collision detection section detects the occurrence of the vehicle-pedestrian collision based on the bumper pressure.

6. The vehicular emergency report apparatus according to claim 5,
wherein the counting section counts the number of the one or more pedestrians in collision with the vehicle based on a change rate of the bumper pressure detected by the pressure sensor.
